(19) United States
(12) Patent Application Publication
(10) Pub. No.: US 2009/0159488 A1
(43) Pub. Date: Jun. 25, 2009

(54) Container having top and bottom reinforcement

(75) Inventors: Terry M. Grant, Auburn, WA (US); Charles C. Habeger, JR., Burien, WA (US); Randall T. Telling, Puyallup, WA (US)

Correspondence Address: INTERNATIONAL PAPER COMPANY, 6285 TRI-RIDGE BOULEVARD, LOVELAND, OH, 45140, US

(73) Assignee: Weyerhaeuser Co., Federal Way, WA (US)

(21) Appl. No.: 11/959,720

(22) Filed: Dec. 19, 2007

(51) Int. Cl. B65D 5/52; B23P 11/00

(52) U.S. Cl. 206/736; 29/428

(57) ABSTRACT

A container is provided, having a casing having center panels and end panels on either end of the center panels. A bottom cap portion is provided perpendicular to the casing wherein the bottom cap portion has a center panel and end panels extending from either end of the center panel. The bottom cap portion has a length which is substantially the same as a length of the casing. A top cap portion is provided on top of and perpendicular to the casing. The top cap portion has a center panel and end panels extending from either end of the center panel The end panels of the bottom cap portion contact the end panels of the casing, and the end panels of the top cap portion contact the end panels of the bottom cap portion.

### FIELD OF THE INVENTION

This invention relates generally to shipping and display type containers.

### BACKGROUND OF THE INVENTION

Many heavy, dense flowable or shifting products exert tremendous inside-to-outward pressure as they slip, shift, slide or flow within a box or tray. Moreover, during transport, boxes which are stacked upon other boxes may exert a force due to, for example, bouncing or other motion. Accordingly, a need exists for container which provides durability.

### BRIEF DESCRIPTION OF THE DRAWINGS

The preferred and alternative embodiments of the present invention are described in detail below with reference to the following drawings.

FIG. 1 is a plan view of a flat blank which forms a casing;

FIG. 2 is plan view of a flat blank which forms a bottom cap portion;

FIG. 3 is plan view of a flat blank which forms a top cap portion;

FIG. 4 is a perspective view of a partially erected container formed from the blanks of FIGS. 1-3;

FIG. 5 is another perspective view of a partially erected container formed from the blanks of FIGS. 1-3;

FIG. 6 is yet another perspective view of a partially erected container formed from the blanks of FIGS. 1-3;

FIG. 7 is yet another perspective view of a partially erected container formed from the blanks of FIGS. 1-3;

FIG. 8 is yet another perspective view of a partially erected container formed from the blanks of FIGS. 1-3;

FIG. 9 is yet another perspective view of a partially erected container formed from the blanks of FIGS. 1-3;

FIG. 10 is yet another perspective view of a partially erected container formed from the blanks of FIGS. 1-3; and

FIG. 11 is a perspective view of an erected container formed from the blanks of FIGS. 1-3.

### DETAILED DESCRIPTION OF THE INVENTION

The present invention provides a container having a casing having center panels and end panels on either end of the center panels. A bottom cap portion is provided perpendicular to the casing wherein the bottom cap portion has a center panel and end panels extending from either end of the center panel. The bottom cap portion has a length which is substantially the same as a length of the casing. A top cap portion is provided on top of and perpendicular to the casing. The top cap portion has a center panel and end panels extending from either end of the center panel. The top cap portion has a length which is substantially the same as a length of the casing. The end panels of the bottom cap portion contact the end panels of the casing, and the end panels of the top cap portion contact the end panels of the bottom cap portion.

The present invention provides a method for assembling a container, having the steps of: providing a first blank having a center panel and end panels on opposite ends of the center panel; providing a second blank having a center panel and end panels on opposite ends of the center panel wherein a length of the center panel of the second blank is substantially the same as a length of the center panel of the first blank; and further wherein the end panels of the second blank have flaps on either side of the end panels; and providing a third blank having a center panel and end panels on opposite ends of the center panel wherein a length of the center panel of the third blank is substantially the same as the length of the center panel of the first blank; and further wherein the end panels of the third blank have flaps on either side of the end panels; positioning the first blank on top of and perpendicular to the second blank; positioning the third blank on top of and perpendicular to the first blank; folding the end panels of the second blank wherein the end panels of the second blank contact the end panels of the first blank; folding the flaps of the second blank wherein at least one of the flaps contacts the center panel of the first blank; folding the end panels of the third blank wherein the end panels of the third blank contact the end panels of the first blank; and folding the flaps of the third blank wherein at least one of the flaps contacts at least one of the flaps of the second blank.

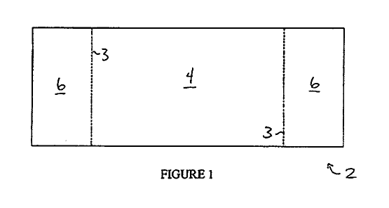

The present invention includes a set of container halves which form a casing. The casing is then covered by top and bottom caps to provide reinforcement. By way of overview and with reference to FIGS. 1-11, an embodiment of the present invention includes blanks 2, 10, 20 arranged to form a stackable container 100. Specific details of the blanks 2, 10, 20 and container 100 are described with more particularity below.

The present invention will now be described with reference to the accompanying FIGS. 1-11 where like numerals correspond to like elements. In all FIGURES, score lines or lines of weakness are shown as broken lines. For the purpose of further description herein, the downward direction is defined as the direction perpendicular to blank 10 that corresponds to the outer surface of the bottom panel when the container 100 has been erected, and the upward direction is defined as the direction perpendicular to the bottom panel that corresponds to the inner surface of the bottom panel when the container has been erected.

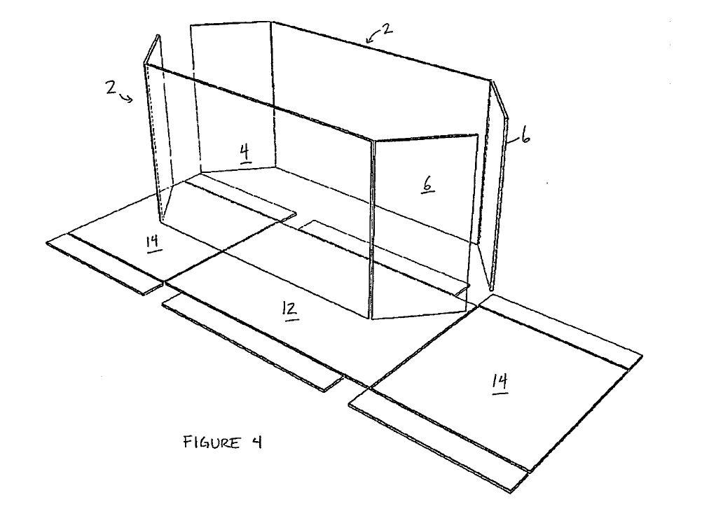

The blanks 2, 10, 20 and resulting container 100 are typically made from any suitable material used in the shipping, storing or displaying of goods. Suitable, nonlimiting examples of such materials include paperboard, containerboard, cardboard, pasteboard, fiberboard, corrugated containerboard, corrugated paperboard, single wall corrugated containerboard, multiwall corrugated containerboard or a combination thereof. As best shown in FIGS. 1-3, blanks 2, 10, 20 are stamped out of any of these suitable materials and assembled in a manner which can be seen in FIGS. 4-11.

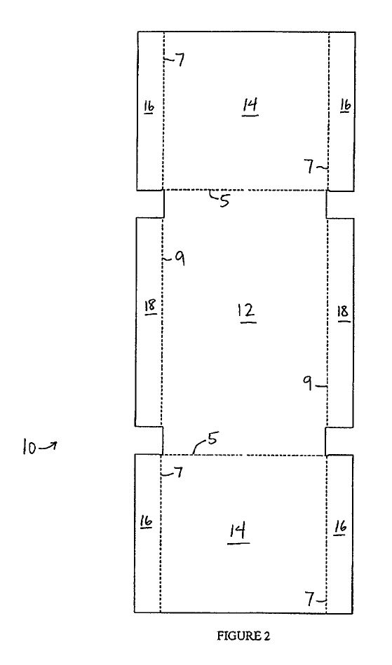

FIG. 1 illustrates a blank 2 which is duplicated wherein both blanks 2 are assembled into a casing which has a side panels and end panels. The blank 2 has a side panel 4 and end panels 6 which are opposite the side panel 4 along fold lines 3. FIG. 2 illustrates a blank 10 which is assembled into a bottom cap portion. The blank 10 has a center panel 12 and end panels 14 which are opposite the center panel 12 along fold lines 5. The end panels 14 have flaps 16 opposite fold line 7. The center panel 12 has flaps 18 which are opposite fold line 9.

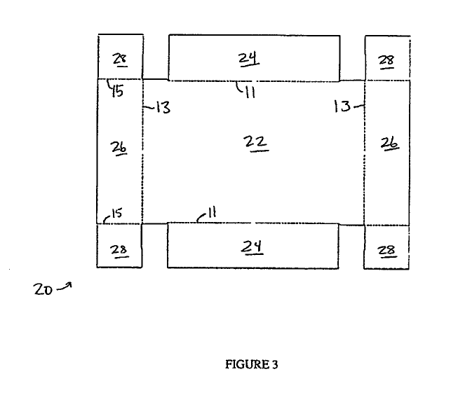

FIG. 3 illustrates a blank 20 which is assembled into a top cap portion. The blank 20 has a center panel 22 and flaps 24 which are opposite to the center panel 22 along fold lines 11. The blank 20 also has end panels 26 which are opposite to the center panel 22 along fold lines 13. The end panels 26 have flaps 28 which are opposite fold lines 15.

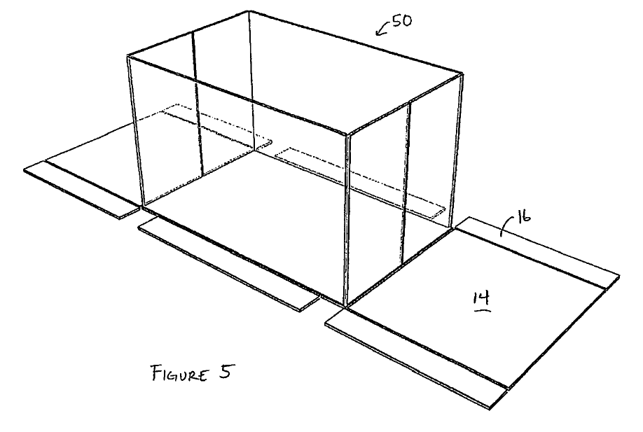

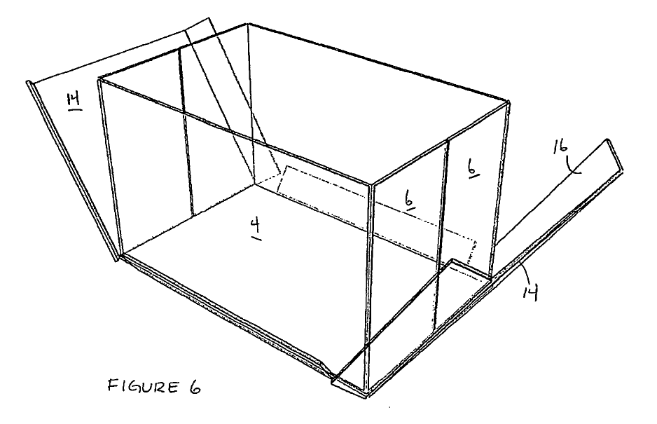

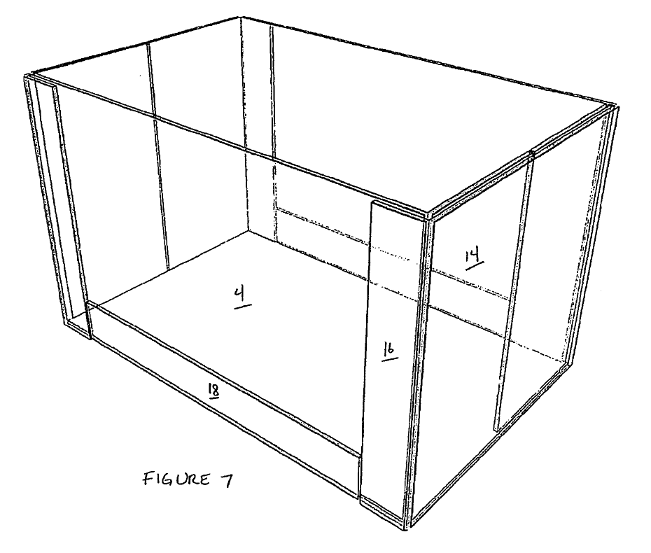

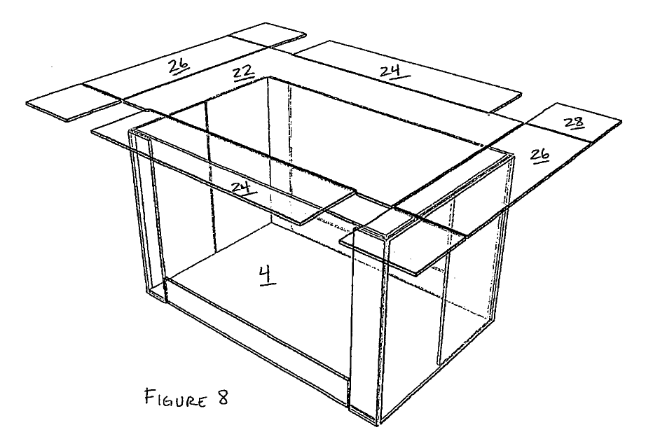

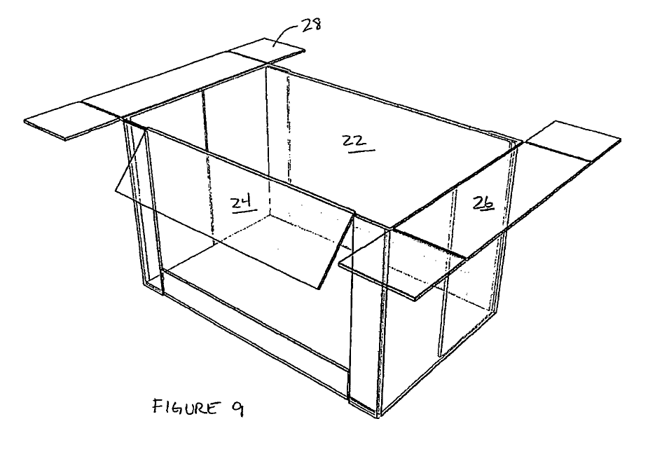

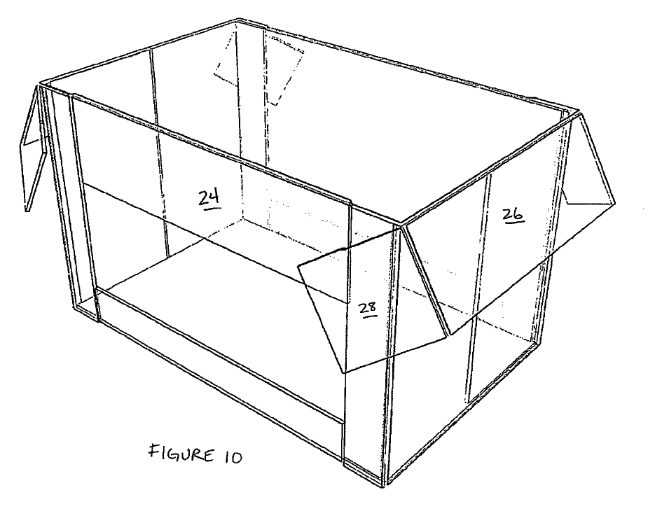

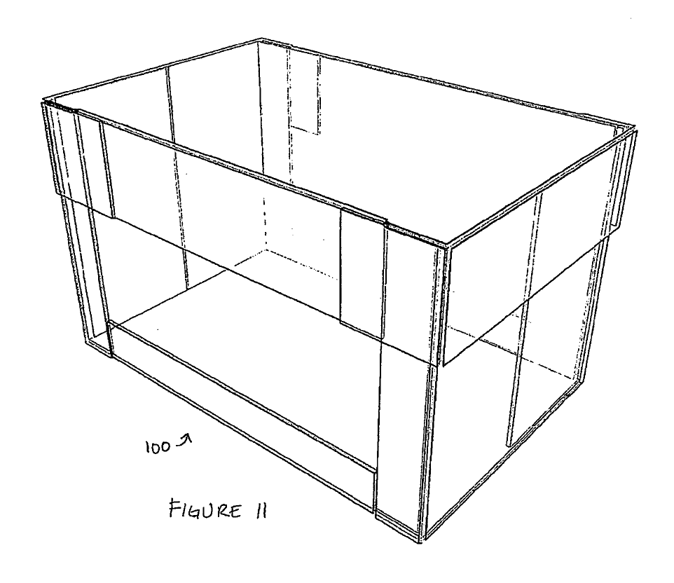

FIGS. 4 through 11 illustrate the method by which the container 100 is assembled. To this end, as illustrated in FIG. 4, the casing halves 2 are positioned such that edges of center panel 4 align with edges of center panel 12 of the blank 10. As seen in FIG. 5, the casing halves 2 are assembled to form a casing 50 having a length which is substantially the length of center panel 12. Moreover the dimensions of all of the blanks 2, 10, 20 may be those which are contemplated by one of ordinary skill in the art depending on a given application. As seen in FIG. 6, panels 14 are folded upwards toward the end panels 6. Flaps 16 are also folded toward the casing 50. FIG. 7 illustrates the panel 14 contacting the end panels 6. Flaps 16 contact the side panels 4. Flaps 18 are folded upwards to also contact the side panels 4. FIG. 8 illustrates the blank 20 being positioned over the casing 50. FIG. 9 illustrates the assembly of the container 100 whereby flaps 24 are folded toward side panel 4 of the casing 50. In FIG. 10 it is seen that end panels 26 are folded toward the flap 14. Moreover, flaps 28 are folded toward the side panel 4. FIG. 11 shows the completed container 100.

In use, container 100 may be filled with product (not shown) and stacked with one or more other containers 100 on a pallet (not shown) or display shelf (not shown). In one possible application, a selected number of containers 100 filled with product (not shown) are stacked on pallet (not shown), and pallet (not shown) may be moved from receiving directly to the display floor of the retailer (perhaps after removing an external common cover, strapping or wrap), where end-user purchasers have access to the pallet of containers. The containers 100 are accessed on the display floor and generate less waste. Purchasers may select product (not shown) from one of the open containers 100, generally from those containers at the top of the stack. The increased strength of the containers allows the containers to better resist vertical collapse or lateral deflection caused by the forces of handling and the like. Handholds (not shown) allow containers to be easily manipulated by stock personnel or others, individually or in stacks of two or more. In addition to the advantages apparent from the foregoing description, the present invention improves the container's strength, especially crushed in the vertical direction. A related advantage is that the contents of such containers are less likely to be damaged.

While an embodiment of the invention has been illustrated and described, as noted above, many changes can be made without departing from the spirit and scope of the invention. For example, the blank may also include other features specified by the customer, such as hand holds, vent holes, grease or moisture barriers and the like without exceeding the scope of the present invention. Accordingly, the scope of the invention is not limited by the disclosure of the preferred embodiment. Instead, the invention should be determined entirely by reference to the claims that follow.

What is claimed is:

1. A method for assembling a container comprising:
providing a first blank having a center panel and end panels on opposite ends of the center panel;
providing a second blank having a center panel and end panels on opposite ends of the center panel wherein a length of the center panel of the second blank is substantially the same as a length of the center panel of the first blank;
and further wherein the end panels of the second blank have flaps on either side of the end panels; and
providing a third blank having a center panel and end panels on opposite ends of the center panel wherein a length of the center panel of the third blank is substantially the same as the length of the center panel of the first blank;
and further wherein the end panels of the third blank have flaps on either side of the end panels;
positioning the first blank on top of and perpendicular to the second blank;
positioning the third blank on top of and perpendicular to the first blank;
folding the end panels of the second blank wherein the end panels of the second blank contact the end panels of the first blank;
folding the flaps of the second blank wherein at least one of the flaps contacts the center panel of the first blank;
folding the end panels of the third blank wherein the end panels of the third blank contact the end panels of the first blank; and
folding the flaps of the third blank wherein at least one of the flaps contacts at least one of the flaps of the second blank.

2. The blanks of claim 1 wherein the blanks are formed from at least one of a paperboard, containerboard, cardboard, pasteboard, fiberboard, corrugated containerboard, corrugated paperboard, single wall corrugated containerboard, and multiwall corrugated containerboard.

3. A container comprising:
a casing having center panels and end panels on either end of the center panels;
a bottom cap portion perpendicular to the casing wherein the bottom cap portion has a center panel and end panels extending from either end of the center panel wherein the bottom cap portion has a length which is substantially the same as a length of the casing; and
a top cap portion on top of and perpendicular to the casing wherein the top cap portion has a center panel and end panels extending from either end of the center panel wherein the top cap portion has a length which is substantially the same as a length of the casing;
wherein the end panels of the bottom cap portion contact the end panels of the casing; and
wherein the end panels of the top cap portion contact the end panels of the bottom cap portion.

4. The container of claim 3 wherein the container is formed from at least one of a paperboard, containerboard, cardboard, pasteboard, fiberboard, corrugated containerboard, corrugated paperboard, single wall corrugated containerboard, and multiwall corrugated containerboard.
